(19) United States
(12) Patent Application Publication
(10) Pub. No.: US 2025/0332828 A1
(43) Pub. Date: Oct. 30, 2025

(54) INKJET RECORDING APPARATUS

(71) Applicant: KYOCERA Document Solutions Inc., Osaka (JP)

(72) Inventors: Hiroomi NAKATSUJI, Osaka (JP); Masato USUI, Osaka (JP); Jun NAKANO, Osaka (JP); Naoko KAWASHIMA, Osaka (JP)

(73) Assignee: KYOCERA Document Solutions Inc., Osaka (JP)

(21) Appl. No.: 19/186,165

(22) Filed: Apr. 22, 2025

(30) Foreign Application Priority Data
Apr. 30, 2024 (JP) 2024-073536

(51) Int. Cl. B41J 2/045; B41J 2/205

(52) U.S. Cl. CPC B41J 2/04508; B41J 2/04536; B41J 2/0457; B41J 2/04581; B41J 2/2054

(57) ABSTRACT

In the inkjet recording apparatus, during execution of a correction mode, an image reading part reads a check chart for density measurement recorded on a sheet by a recording part, whereby a controller acquires density information about recording heads. The controller also repeatedly corrects a drive condition for the recording heads until the acquired density information about the recording heads comes to not more than a predetermined threshold value. When the drive condition for the recording heads has been corrected to a specified number of times, it is decided whether or not the density information about the recording heads has been converging toward a specified value each time the drive condition for the recording heads is corrected, where given that the density information about the recording heads has not been converging toward the specified value, the threshold value is changed.

### INCORPORATION BY REFERENCE

This application is based on and claims the benefit of priority from Japanese Patent Application No. 2024-073536 filed on Apr. 30, 2024, the contents of which are hereby incorporated by reference.

### BACKGROUND

The present disclosure relates to an inkjet recording apparatus.

A conventional inkjet recording apparatus includes a recording part, an image reading part, and a controller. The recording part ejects ink from a plurality of nozzles in each of a plurality of recording heads to record an image on a sheet. The image reading part reads density of the image recorded on the sheet. The controller controls the recording part and the image reading part.

The controller instructs the image reading part to read out a check chart for density measurement recorded on the sheet by the recording part to acquire density information about the recording heads. Also, based on the acquired density information about the recording heads, the controller corrects a drive condition for the recording heads. As a result of this, quantity of ink ejection of the recording heads can be adjusted so that density variations of images recorded on sheets can be suppressed. Thus, deterioration of image quality due to density variations can be suppressed.

However, with conventional inkjet recording apparatuses, there has been a possibility that density variations in a check pattern would vary sheet by sheet in cases where a check chart is recorded on sheets having quality variations such as recycled paper. For this reason, it would be likely that acquired density information about the recording heads also vary sheet by sheet. Due to this, correcting a drive condition for the recording heads could lead to deterioration of image quality with density variations remaining unsolved.

In view of the above-described problems, the present disclosure has an objective of providing an inkjet recording apparatus capable of suppressing deterioration of image quality.

### SUMMARY

An inkjet recording apparatus according to one aspect of the present disclosure includes a recording part, an image reading part, and a controller. The recording part ejects ink from a plurality of nozzles in each of a plurality of recording heads to record an image on a sheet. The image reading part reads density of the image recorded on the sheet. The controller controls the recording part and the image reading part. The controller is enabled to execute a correction mode for correcting a drive condition for the recording heads during execution of a normal image formation mode. During execution of the correction mode, the controller acquires density information about the recording heads by the image reading part reading a check chart for density measurement recorded on the sheet by the recording part. Also, the drive condition for the recording heads is repeatedly corrected until the acquired density information about the recording heads comes to not more than a predetermined threshold value. When the drive condition for the recording heads has been corrected to a specified number of times, it is decided whether or not the density information about the recording heads has been converging toward a specified value each time the drive condition for the recording heads is corrected. Given that the density information about the recording heads has not been converging toward the specified value, the threshold value is changed.

This and other objects of the present disclosure, and specific benefits obtained according to the present disclosure, will become more apparent from the description of an embodiment which follows.

### BRIEF DESCRIPTION OF THE DRAWINGS

FIG. 1 is a cross-sectional view showing a schematic configuration of an inkjet recording apparatus 100 according to an embodiment of the disclosure;

FIG. 2 is a plan view of a recording part 104 of the inkjet recording apparatus 100 of FIG. 1;

FIG. 3 is a block diagram of the inkjet recording apparatus 100 according to the embodiment of the disclosure;

FIG. 4 is a plan view showing one example of a check chart 20 for density measurement according to the embodiment of the disclosure;

FIG. 5 is a flowchart showing an execution example of correction mode in the inkjet recording apparatus 100 according to the embodiment of the disclosure;

FIG. 6 is a chart showing a relationship between number of corrections of a drive condition for recording heads 1041 and density variations;

FIG. 7 is a chart showing a relationship between number of corrections of a drive condition for the recording heads 1041 and density variations; and

FIG. 8 is a chart showing a relationship between number of corrections of a drive condition for the recording heads 1041 and density variations.

### DETAILED DESCRIPTION

### <1. Configuration of Inkjet Recording Apparatus>

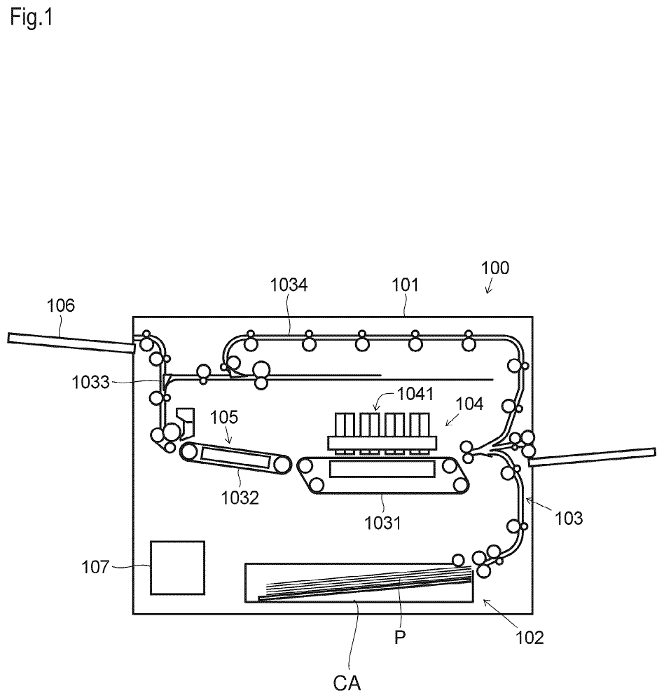

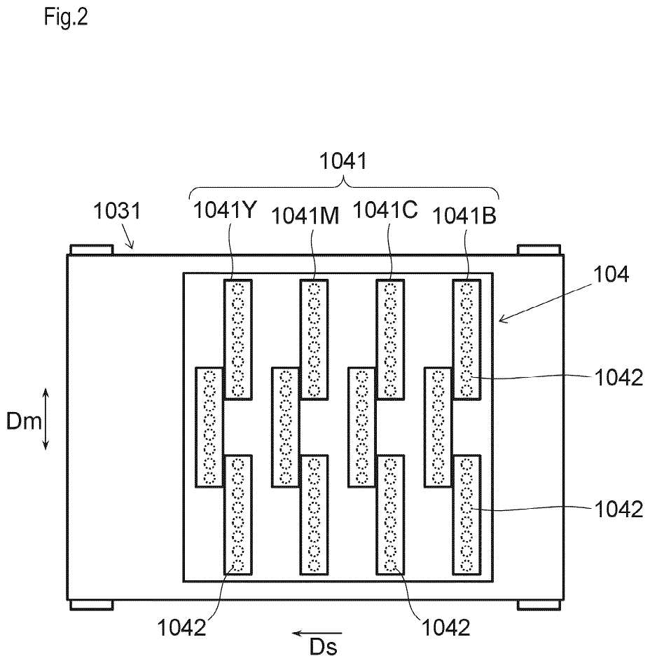

Hereinafter, an embodiment of the present disclosure will be described with reference to the accompanying drawings. FIG. 1 is a cross-sectional view showing a schematic configuration of an inkjet recording apparatus 100 to which a density-variation detection method for nozzles of the embodiment is applied. FIG. 2 is a plan view of a recording part 104 of the inkjet recording apparatus 100 of FIG. 1.

The inkjet recording apparatus 100 is, for example, a printer of inkjet recording type. The inkjet recording apparatus 100 includes a main body (apparatus body) 101, a sheet feed part 102, a sheet conveyance part 103, a recording part 104, a drying part 105, a sheet discharge part 106, and a controller 107.

The sheet feed part 102, containing a plurality of sheets (recording medium) P, separates and feeds out the sheets S one by one during recording process. The sheet feed part 102 includes a cassette CA. The sheets P are contained in the cassette CA. That is, the inkjet recording apparatus 100 is equipped with the sheet feed part 102 including the cassette CA in which the sheets P are contained. The cassette CA is settable to and removable from the apparatus body 101. Work of setting the sheets P into the cassette CA is to be done by a user. For the setting work, the user pulls out the cassette CA from the apparatus body 101, setting the sheets P into the cassette CA and fitting the cassette CA to the apparatus body 101.

The sheet conveyance part 103 conveys a sheet P, which has been fed out from the sheet feed part 102, to the recording part 104 and the drying part 105, and discharges the sheet P, after its being recorded and dried, onto a sheet discharge part 106. The sheet conveyance part 103 includes a first belt conveyance part 1031 and a second belt conveyance part 1032. The first belt conveyance part 1031 and the second belt conveyance part 1032 convey the sheet P while sucking and holding the sheet P on an upper surface of an endless belt. In a case where double-sided recording is performed, the sheet conveyance part 103 directs the sheet P, which has been recorded on its first surface and dried, toward an inversion-and-conveyance part 1034 by a branch part 1033, followed by switchover of the conveyance direction, making the sheet P, which has been top-bottom inverted, conveyed once again to the recording part 104 and the drying part 105.

The recording part 104 is placed above the first belt conveyance part 1031, with a specified distance thereto, so as to be opposed to the sheet P being conveyed as it is sucked and held on the upper surface of the first belt conveyance part 1031. The recording part 104 has recording heads 1041 of, for example, line-type inkjet mode. The recording heads 1041 include recording heads 1041B, 1041C, 1041M, 1041Y corresponding to four colors of black, cyan, magenta, and yellow, respectively. In each one group of the individual-color recording heads 1041, a plurality (e.g., three) of recording heads are arrayed in a staggered arrangement along a sheet widthwise direction (arrow line Dm of FIG. 2=main scanning direction) perpendicular to a sheet conveyance direction (arrow line Ds of FIG. 2=sub scanning direction). It is noted that number and arrangement of the recording heads 1041 are not limited to the above-described example).

Plural nozzles 1042 are placed in arrays along the sheet widthwise direction (main scanning direction) Dm, and enabled to eject ink over an entire recording region. The recording part 104 ejects ink sequentially from the four-color recording heads 1041B, 1041C, 1041M, 1041Y toward the sheet P being conveyed by the first belt conveyance part 1031 to record a full-color image or a monochrome image on the sheet P.

In more detail, the recording heads 1041 are inkjet heads each having a plurality of recording elements including the plurality of nozzles 1042. The nozzles 1042 are placed in bottom portions of the recording heads 1041.

The recording elements include a pressure chamber (not shown) for storing ink, and a piezoelectric element (not shown) provided on a side wall of the pressure chamber, in addition to the nozzles 1042. The pressure chamber communicates with the nozzles 1042. The recording heads 1041 are supplied from the controller 107 with a drive voltage, as a drive condition, for deformatively operating the piezoelectric element in response to a pixel value of image data.

As a result, the piezoelectric element deformatively operates so that the pressure chamber is deformed in response to the drive voltage derived from the recording heads 1041. When this occurs, internal pressure of the pressure chamber is changed, causing ink to be ejected from the nozzles 1042 communicating with the pressure chamber. Thus, in each of the nozzles 1042, ink of a liquid quantity responsive to the pixel value of the image data is ejected toward the sheet P, so that an image is formed on the sheet P.

The drying part 105 is placed downstream of the recording part 104 in the sheet conveyance direction, and has the second belt conveyance part 1032 provided therein. The sheet P, on which an ink image has been recorded in the recording part 104, undergoes ink drying while being conveyed in the drying part 105 as it is sucked and held by the second belt conveyance part 1032.

The controller 107 includes an unshown CPU and a storage part, as well as other unshown electronic circuits and electronic components. Based on control-dedicated programs and data stored in the storage part, the CPU performs processing related to functions of the inkjet recording apparatus 100 by controlling operations of the component elements provided in the inkjet recording apparatus 100. The sheet feed part 102, the sheet conveyance part 103, the recording part 104, and the drying part 105, upon receiving instructions individually from the controller 107, perform recording on the sheet P in linkage with one another. The storage part consists of, for example, nonvolatile storage devices exemplified by unshown program ROM (Read Only Memory), data ROM, or the like, and volatile storage devices exemplified by RAM (Random Access Memory) or the like, in combination of these devices.

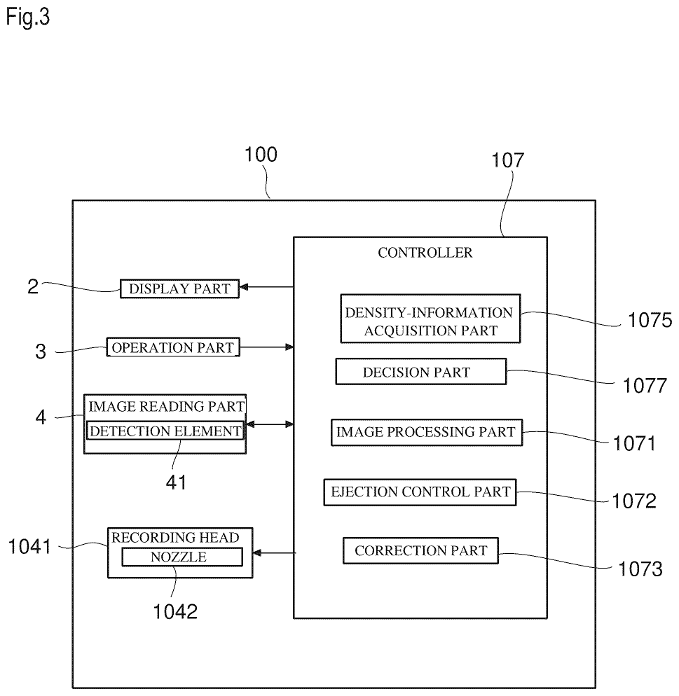

FIG. 3 is a block diagram of the inkjet recording apparatus 100. The inkjet recording apparatus 100 further includes a display part 2, an operation part 3, an image reading part 4. A density-variation detection part 1 is enabled to execute various processes for detection of density variations of the nozzles 1042. The display part 2, the operation part 3, and the image reading part 4 are connected to the controller 107.

The display part 2 is made up by, for example, a liquid crystal display panel or the like, and enabled to display various types of information about the controller 107, information as to processing results, and the like. The operation part 3, which is an input device composed of, for example, a keyboard, a touch panel, and the like, is enabled to input operational information, setting information, and the like for the controller 107.

The image reading part 4, including an image sensor such as a line sensor, optically reads an image of a sheet P to generate image data responsive to the image, transmitting the image data to the controller 107. Based on image data of a check chart 20, the controller 107 executes various processes to detect density variations of the nozzles 1042.

The image sensor has, for example, a plurality of detection elements 41, a light source, a lens, and the like. The detection elements 41 are a plurality of photoelectric conversion elements which are arrayed along the sheet widthwise direction and which count generally equal in number to the plurality of nozzles 1042. The image reading part 4 detects ink ejected onto the sheet P by the detection elements 41 receiving, via the lens, reflected light of light irradiated from the light source toward the sheet P.

The image reading part 4 is enabled to acquire an image formed on the sheet P, with the check chart 20 recorded thereon, in units of a plurality of wavelength components, for example, by three wavelengths of red (R), green (G), and blue (B). Usable as the detection elements of the line sensor are CCD (Charge Coupled Device) type image pickup elements, CMOS (Complementary Metal Oxide Semiconductor) type image pickup elements, and the like. In addition, the image reading part 4 is not limited to those of the above-described configuration, and for example, an area sensor with image pickup elements provided in two-dimensional arrangement may be used instead of the line sensor. In this embodiment, the image reading part 4 exerts colorimetry of images formed on the sheet P on a basis of RGB values. However, the colorimetry may also be based on Lab values.

The controller 107 controls recording operations by the plurality of nozzles 1042. The controller 107 includes a density-information acquisition part 1075, a decision part 1077, an image processing part 1071, an ejection control part 1072, and a correction part 1073. Individual functions of these component elements are implemented by execution of arithmetic processes according to specified programs.

The density-information acquisition part 1075 acquires density values of the check chart 20 on a basis of image data acquired from the image reading part 4. The density-information acquisition part 1075 also acquires density information about recording heads 1041 corresponding to the check chart 20 on a basis of the acquired density values.

The decision part 1077, using threshold values previously stored in the storage part, makes a decision as to density information about the recording heads 1041 acquired by the density-information acquisition part 1075. As a result of this, it can be decided whether or not density variations have occurred to part of the check chart 20. When deciding that density variations have occurred to part of the check chart 20, the decision part 1077 specifically determines causal nozzles 1042 for density variations from the foregoing decision result.

Based on recording-dedicated image data inputted to the inkjet recording apparatus 100, the image processing part 1071 generates recording data for actually accomplishing the recording onto the sheet P. Further, in order to specifically determine the causal nozzles 1042 for density variations during execution of correction mode, the image processing part 1071 generates recording data for allowing the density-measurement check chart 20 to be recorded on the sheet P.

The ejection control part 1072 controls ink ejection operations of individual plural nozzles 1042 in such fashion that an image responsive to the recording data generated by the image processing part 1071 is recorded on the sheet P. M ore specifically, the ejection control part 1072 controls a drive voltage for recording heads 1041 on a basis of a set drive condition for the recording heads 1041, thus enabled to control ejection quantities of ink drops ejected from the individual nozzles 1042, respectively.

Given that abnormal nozzles 1042 are specifically determined in the decision part 1077, the correction part 1073 executes various types of correction processes. For example, the correction part 1073 is given, from the decision part 1077, information that density variations have occurred to part of the check chart 20, as well as density information about causal recording heads 1041 for the density variations. The correction part 1073 corrects the drive condition for the causal recording heads 1041 on a basis of the density information. Thus, increasing or decreasing the ejection quantity of ink drops ejected by the individual nozzles 1042 of the causal recording heads 1041 for the density variations allows occurrence of density variations to be suppressed.

In addition, the drive condition for the recording heads 1041 is, for example, magnitude of voltage value (voltage amplitude) or application time of the drive voltage applied to the recording heads 1041. Correcting the drive condition for the recording heads 1041 enables adjustment of the ejection quantity of ink drops ejected by each of the nozzles 1042. In addition, the ink ejected from the nozzles 1042 may be given by using hot-melt ink compositions derived from wax or other materials that are solid at room temperature, phase-change ink compositions that are changeable in phase into gel state on the recording medium, or the like.

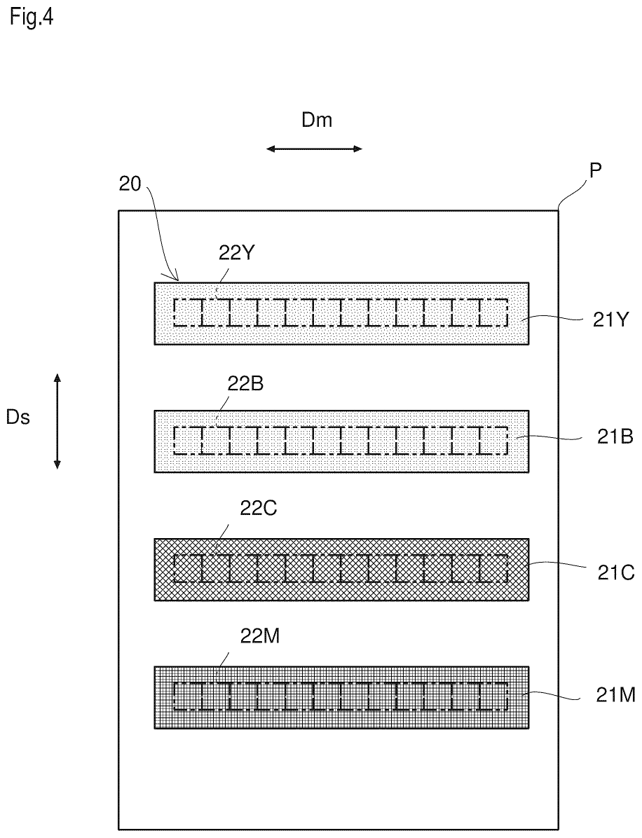

FIG. 4 is a plan view showing one example of the check chart 20 for detection of density variations in the embodiment. In FIG. 4, reading areas 22Y, 22B, 22C, 22M are depicted by one-dot chain line. It is noted that identification signs ‘B’, ‘C’, ‘M’, ‘Y’ representing individual colors may be omitted except when any particular restrictions of colors are needed.

The check chart 20 includes check patterns 21Y, 21B, 21C, 21M that are depicted by ink drops of individual colors of yellow, black, cyan, and magenta, respectively.

In this embodiment, the check patterns 21Y, 21B, 21C, 21M are half-tone patterns that are strip-shaped patterns each having a specified length in the sub scanning direction Ds and extending over an entire range of the main scanning direction Dm. FIG. 4 shows an example in which the check patterns 21Y, 21B, 21C, 21M are arrayed in order of yellow (21Y), black (21B), cyan (21C), and magenta (21M) starting with the uppermost side of the sub scanning direction; however, the present disclosure is not limited to this order.

The check patterns 21Y, 21B, 21C, 21M are partitioned by the plural reading areas 22Y, 22B, 22C, 22M, respectively, that are arrayed in the main scanning direction Dm. The reading areas 22Y, 22B, 22C, 22M are used to decide whether or not density information about recording heads 1041 is converging toward a specified value each time the drive condition for the recording heads 1041 is corrected.

In this embodiment, the reading areas 22Y, 22B, 22C, 22M are arrayed in the main scanning direction Dm on a basis of twelve reading areas per color. Also, each one of the reading areas 22Y, 22B, 22C, 22M is square-shaped and composed of a plurality of pixels (nozzles 1042).

The check patterns 21Y, 21B, 21C, 21M are subjected to measurement in which, for example, density values of the individual reading areas 22Y, 22B, 22C, 22M arrayed in the main scanning direction Dm are measured. Those density values are measured each time the drive condition for the recording heads 1041 is corrected. Then, with comparisons made among acquired density values, it can be decided whether or not the density values are converging toward a specified value each time the drive condition for the recording heads 1041 is corrected. That is, through comparisons among acquired density values, it can be decided whether or not density information about the recording heads 1041 is converging toward a specified value each time the drive condition for the recording heads 1041 is corrected.

In addition, although density information about the recording heads 1041 is acquired based on density values of the reading areas 22Y, 22B, 22C, 22M, respectively, in this embodiment, the disclosure is not limited to this. For example, with drive voltage values for recording heads 1041 measured upon each correction, density information about the recording heads 1041 may be acquired based on drive voltage values for the recording heads 1041.

When ink drops are ejected from plural nozzles 1042 of the individual recording heads 1041 in response to drive voltages of equal voltage value, the ejection quantity of ink drops is desirably uniformized. However, due to temperature variations in the recording heads 1041 or characteristic variations of the recording elements of the recording heads 1041 or the like, there may arise variations in the ejection quantity of ink drops.

With variations in the ejection quantity of ink drops involved among a plurality of nozzles 1042, there would arise density variations in the plurality of reading areas 22Y, 22B, 22C, 22M arrayed in the main scanning direction Dm. Occurrence of such density variations would lead to deterioration of image quality of formed images.

Those density variations can be managed by changing the drive voltage as a drive condition partly within the recording heads 1041. However, in cases where paper of such types involving quality variations as recycled paper, rough paper, and backside of printed sheets (so-called back paper) is used as the sheet P, there is a possibility that density variations in the check patterns 21Y, 21B, 21C, 21M become more noticeable (unstable) sheet P by sheet P. Accordingly, there has also been a possibility that density information about recording heads 1041 acquired from the check patterns 21Y, 21B, 21C, 21M varies sheet P by sheet P. Thus, even with correction of the drive condition for the recording heads 1041 applied, density variations would remain unsolved so that deterioration of image quality could occur.

In this embodiment, a correction mode in which the drive condition for the recording heads 1041 is corrected is executable, so that the drive condition for the recording heads 1041 is corrected repeatedly until calculated density information about the recording heads 1041 comes to not more than a predetermined threshold value. As a result, occurrence of density variations during execution of a normal image formation mode can be suppressed.

Also, when the drive condition for the recording heads 1041 has been corrected to a specified number of times, it is decided whether or not density information about the recording heads 1041 has been converging toward a specified value each time the drive condition for the recording heads 1041 is corrected. In this case, given that the density information about the recording heads 1041 has not been converging toward the specified value, the controller 107 decides that the sheet P's having quality variations is the cause that density variations remain unsolved even in cases where the drive condition for the recording heads 1041 is repeatedly corrected.

When it is decided that the cause is the sheet P's having quality variations, the controller 107 changes the threshold value. In this case, the threshold value to be changed is, for example, a threshold value corresponding to cases of sheets P's having quality variations and previously stored in the storage part. The controller 107 (decision part 1077) makes a decision as to density information about the recording heads 1041 by using the after-change threshold value, deciding whether or not density variations have occurred to part of the check chart 20. When the density information about the recording heads 1041 is beyond the after-change threshold value, the decision part 1077 decides that the cause of density variations occurring to part of the check chart 20 is other than quality variations of the sheet P.

Meanwhile, when the density information about the recording heads 1041 is not more than the after-change threshold value, the decision part 1077 decides that the cause of density variations occurring to part of the check chart 20 is quality variations of the sheet P, and that the drive condition for the recording heads 1041 has been properly corrected by the preceding-time correction. Accordingly, the drive condition for the recording heads 1041 can be corrected with considerations given to presence of quality variations of the sheet P. Consequently, during execution of the normal image formation mode, occurrence of density variations can be suppressed while presence of quality variations of the sheet P is managed, allowing quality deterioration of formed images to be reduced.

In addition, it is preferable to display, on the display part 2, a phase that the threshold value has been changed. By doing so, the user is allowed to recognize that correction for solving density variations has been executed during execution of the normal image formation mode.

On the other hand, given that the density information about the recording heads 1041 is converging toward a specified value, the controller 107 decides that the cause of density variations remaining unsolved even with the drive condition for the recording heads 1041 repeatedly corrected is other than presence of quality variations of the sheet P.

In this case, since density variations have not been solved even with the drive condition for the recording heads 1041 corrected to more than a specified number of times, execution of the correction mode is once halted. Limiting the number of corrections of the drive condition for the recording heads 1041 to a specified number of times of corrections makes it possible to limit execution time of the correction mode, thus allowing the user's standby time to be reduced. In addition, it is preferable to display an error massage on the display part 2 when execution of the correction mode is halted. By doing so, the user is allowed to recognize occurrence of density variations.

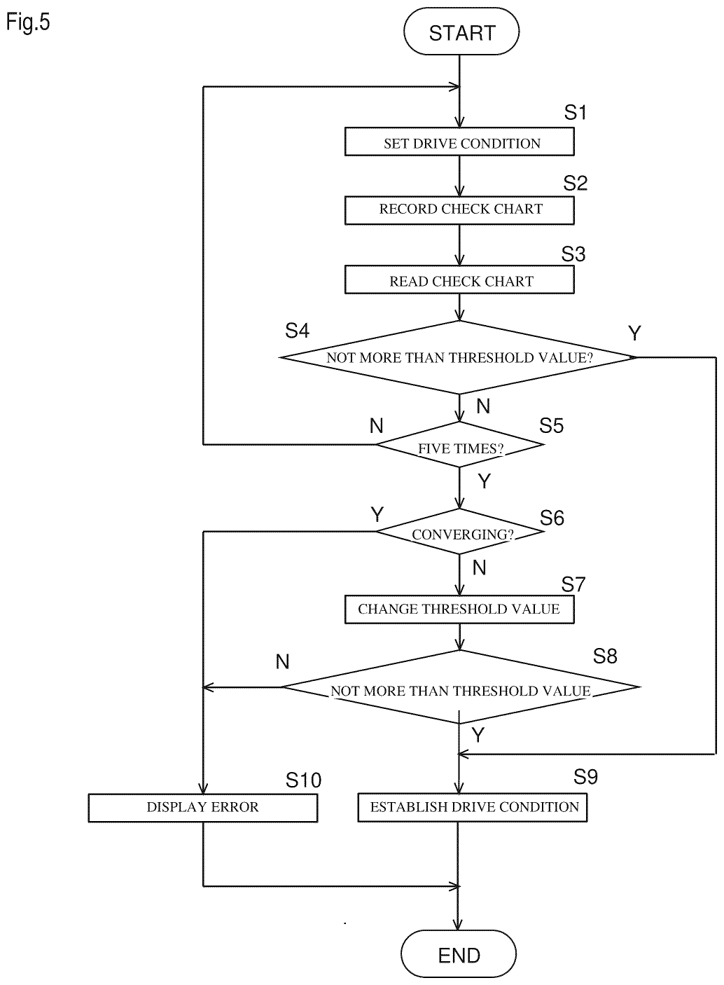

FIG. 5 is a flowchart showing an execution example of the correction mode in the inkjet recording apparatus 100 according to a first embodiment. In this embodiment, when the cassette CA is set on the apparatus body 101, the correction mode is executed. After this, when the sheet P is replaced with another, the drive condition for the recording heads 1041 is corrected in correspondence to the type of the sheet P. Accordingly, during execution of the image formation mode, occurrence of density variations is suppressed, so that quality deterioration of formed images can be reduced. In addition, the correction mode may be executed by the user's input in the operation part 3.

Upon a start of execution of the correction mode, the drive condition for the recording heads 1041 is set (step S1). Given that the drive condition for the recording heads 1041 has never been corrected, the drive condition for the recording heads 1041 is returned to its initial setting. The drive condition of the initial setting is, for example, an identical drive voltage among all the recording heads 1041.

Next, the check chart 20 for density measurement is recorded on a sheet P on a basis of the drive condition for the recording heads 1041 set at step S1 (step S2). More specifically, image data of the check chart 20 is transmitted to the image processing part 1071, where recording data of the image data is generated. Based on the recording data, the ejection control part 1072 controls the recording heads 1041 to make the check chart 20 recorded on the sheet P. In this case, the drive voltage for the recording heads 1041 is controlled based on the drive condition for the recording heads 1041 set at step S1. It is noted that image data of the check chart 20 is previously stored in the storage part or the like within the inkjet recording apparatus 100.

Next, the check chart 20 recorded on the sheet P is optically read by the image reading part 4 (step S3). More specifically, the check chart 20 is read out by a plurality of detection elements 41 arrayed along the main scanning direction Dm. The image reading part 4 generates image data corresponding to the read image, transmitting the image data to the density-information acquisition part 1075.

Based on the image data of the check chart 20 received from the image reading part 4, the density-information acquisition part 1075 acquires density information about the recording heads 1041. The decision part 1077 makes a decision as to the density information about the recording heads 1041 acquired by the density-information acquisition part 1075 by using a threshold value previously stored in the storage part (step S4). As a result of this, it can be decided whether or not density variations have occurred to part of the check chart 20. When the decision part 1077 decides that the density information about the recording heads 1041 is beyond the threshold value with density variations occurring to part of the check chart 20 (NO at step S4), the decision part 1077 specifically determines nozzles 1042 being the cause of the density variations from the decision result, followed by transition to step S5.

On the other hand, when the decision part 1077 decides that the density information about the recording heads 1041 is not more than the threshold value with no density variations occurring to the check chart 20 (YES at step S4), the processing moves on to step S9. At step S9, the drive condition for the recording heads 1041 set at the preceding step S1 is set to a drive condition for the recording heads 1041 in the normal image formation mode, followed by an end of the correction mode.

In addition, at step S4, invariable threshold values previously stored in the storage part or the like are used for detection of density variations. Threshold values for individual colors of yellow, black, cyan, and magenta are previously stored.

At step S5, during execution of the correction mode, it is decided whether or not a sequence from step S1 to step S4 has reached a specified upper-limit number of times. In this embodiment, the upper-limit number of times to which the sequence of steps S1 to S4 is repeated is previously set to five times. Therefore, when the sequence of steps S1 to S4 has been repeated to five times, the processing moves on to step S6 (YES at step S5). In addition, the upper-limit number of times to which the sequence of steps S1 to S4 is repeated, although set to five times in this embodiment, is not limited to this.

On the other hand, given that the number of times to which the sequence of steps S1 to S4 has been repeated is less than five times, the processing returns to step S1, followed by once more execution of the sequence of steps S1 to S4. In this case, at step S1, the drive condition for the recording heads 1041 is corrected based on density information about the recording heads 1041 acquired at the preceding step S4, and the corrected drive condition for the recording heads 1041 is set.

At step S2, based on the drive condition for the recording heads 1041 corrected at step S1, the check chart 20 for density measurement is recorded on the sheet P. In this case, a new sheet P is fed each time the sequence of steps S1 to S4 is repeated.

By the sequence of steps S1 to S4 being repeated, density variations due to temperature variations inside the recording heads 1041 or characteristic variations of recording elements of the recording heads 1041 or the like can be corrected with high precision.

At step S6, it is decided whether or not the density information about the recording heads 1041 has been converging toward a specified value each time the sequence of steps S1 to S4 is repeated so that the drive condition for the recording heads 1041 is corrected.

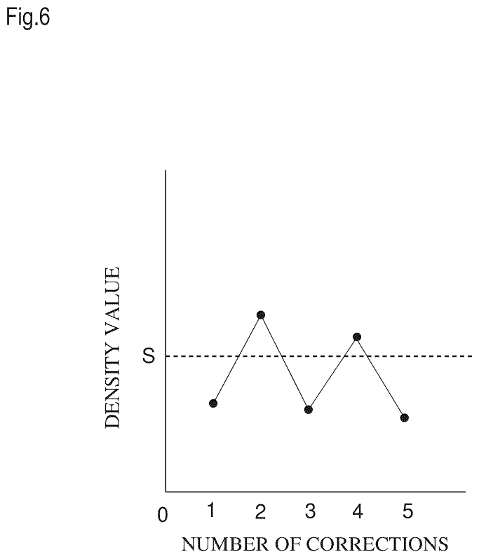

FIGS. 6 to 8 are charts showing relationships between number of corrections of the drive condition for the recording heads 1041 and density values, each figure showing a relationship between the number of corrections for the drive condition for the recording heads 1041 and the density value in any one of the reading areas 22Y, 22B, 22C, 22M where density variations have occurred. As shown in FIG. 6, the density value in the check chart 20 after correction repeats high and low values with a convergent value S interposed therebetween. Meanwhile, given that the density value is not converging to the convergent value S (NO at step S6), the processing moves on to step S7.

In this case, the density information about the recording heads 1041 is not converging toward the specified value. Therefore, the controller 107 decides that the cause of density variations remaining unsolved even with the drive condition for the recording heads 1041 having been repeatedly corrected is presence of quality variations of the sheet P.

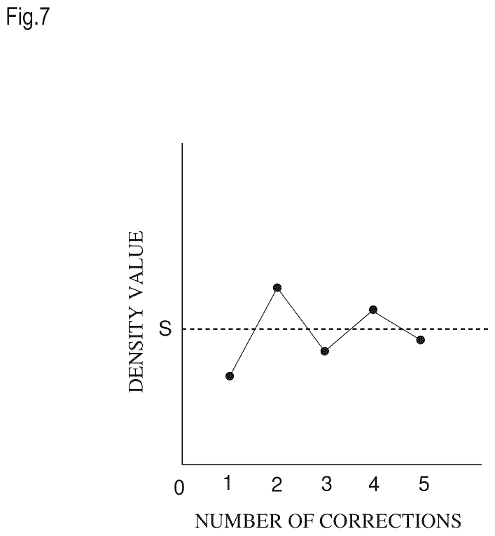

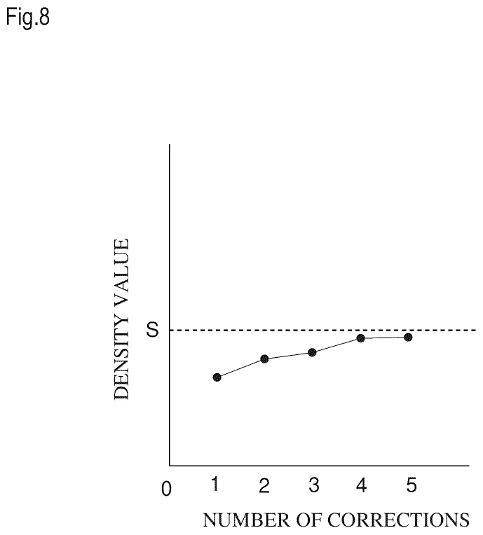

Meanwhile, given that the density value in the check chart 20 after correction is converging to the convergent value S as shown in FIGS. 7 and 8 (YES at step S6), the processing moves on to step S10.

In this case, the density information about the recording heads 1041 is converging toward the specified value. Therefore, the controller 107 decides that the cause of density variations remaining unsolved even with the drive condition for the recording heads 1041 having been repeatedly corrected is other than presence of quality variations of the sheet P. At step S10, an error massage is displayed on the display part 2, followed by a halt of execution of the correction mode.

At step S7, the threshold value is changed and set again, followed by transition to step S8. An after-change threshold value is a threshold value corresponding to a case with quality variations of the sheet P present as described above, and has previously been stored in the storage part.

At step S8, the decision part 1077 decides whether or not density information about the recording heads 1041 acquired at the preceding step S4 is not more than the after-change threshold value. By doing so, it can be decided based on the after-change threshold value whether or not density variations have occurred to part of the check chart 20. When the decision part 1077 decides that the density information about the recording heads 1041 is beyond the threshold value with density variations having occurred to part of the check chart 20 (NO at step S8), the processing moves on to step S10, where an error massage is displayed on the display part 2, followed by a halt of execution of the correction mode.

Meanwhile, given that the density information about the recording heads 1041 is not more than the after-change threshold value at step S8 (YES at step S8), the decision part 1077 decides that density variations have occurred to the check chart 20 for the cause of quality variations of the sheet P, followed by transition to step S9.

At step S9, the drive condition for the recording heads 1041 set at the preceding step S1 is set to a drive condition for the recording heads 1041 in the normal image formation mode, followed by an end of the correction mode. Consequently, during execution of the next-time image formation mode, occurrence of density variations can be suppressed while presence of quality variations in the sheet P is managed, allowing quality deterioration of formed images to be reduced.

Although an embodiment of the present disclosure has been described hereinabove, the scope of the disclosure is not limited to this and may be carried out as it is changed and modified in various ways without deviating from the gist of the disclosure.

For example, although the image reading part 4 is included in the inkjet recording apparatus 100 in this embodiment, yet the image reading part 4 may also be provided as a separate device other than the inkjet recording apparatus 100.

The present disclosure is utilizable for such maintenance as detecting density variations of nozzles in inkjet recording apparatuses.

What is claimed is:

1. An inkjet recording apparatus comprising:
a recording part for ejecting ink from a plurality of nozzles in each of a plurality of recording heads to record an image on a sheet;
an image reading part for reading density of the image recorded on the sheet; and
a controller for controlling the recording part and the image reading part, wherein
the controller is enabled to execute a correction mode for correcting a drive condition for the recording heads during execution of a normal image formation mode,
in the controller, during execution of the correction mode, the image reading part reads a check chart for density measurement recorded on the sheet by the recording part to acquire density information about the recording heads, and the drive condition for the recording heads is repeatedly corrected until the acquired density information about the recording heads comes to not more than a predetermined threshold value; and
when the drive condition for the recording heads has been corrected to a specified number of times, it is decided whether or not the density information about the recording heads has been converging toward a specified value each time the drive condition for the recording heads is corrected, where given that the density information about the recording heads has not been converging toward the specified value, the threshold value is changed.

2. The inkjet recording apparatus according to claim 1, wherein
given that the density information about the recording heads has been converging toward the specified value, the controller halts execution of the correction mode.

3. The inkjet recording apparatus according to claim 1, further comprising
a display part for displaying information about the recording part, wherein
the controller displays, on the display part, a phase that the threshold value has been changed.

4. The inkjet recording apparatus according to claim 2, further comprising
a display part for displaying information about the recording part, wherein
when halting execution of the correction mode, the controller displays an error massage on the display part.

5. The inkjet recording apparatus according to claim 1, wherein
the controller adjusts a drive voltage for the recording heads to correct the drive condition for the recording heads.

6. The inkjet recording apparatus according to claim 1, further comprising
a sheet feed part including a cassette for containing the sheet, wherein
when the cassette is set on an apparatus body including the recording part, the controller executes the correction mode.
